(19) United States
(12) Patent Application Publication
(10) Pub. No.: US 2017/0224160 A1
(43) Pub. Date: Aug. 10, 2017

(54) COOKING APPARATUS USING COOKING MEDIA WITH MICROWAVE

(71) Applicant: Henny Penny Corporation, Eaton, OH (US)

(72) Inventors: William M. Casey, Kettering, OH (US); Wayne G. Love, Glen Ellyn, IL (US)

(21) Appl. No.: 15/501,234

(22) PCT Filed: Aug. 11, 2015
(86) PCT No.: PCT/US2015/044593

§ 371 Date: Feb. 2, 2017

Related U.S. Application Data
(60) Provisional application No. 62/036,612, filed on Aug. 12, 2014.

(51) Int. Cl. A47J 37/12; H05B 6/76; A23L 5/10; H05B 6/64

(52) U.S. Cl. CPC A47J 37/1261; H05B 6/6414; H05B 6/763; H05B 6/6408; A47J 37/1266; A47J 37/128; A47J 37/1295; A23L 5/11; A23L 5/15; A23V 2002/00

(57) ABSTRACT

A cooking apparatus may include a cooking chamber, a heating mechanism, a microwave generator, and a waveguide. The cooking chamber may hold cooking media. The heating mechanism may be disposed at the cooking chamber and may heat the cooking media. The microwave generator may produce microwave energy. The waveguide may be disposed on the cooking chamber and may transmit the microwave energy from the microwave generator to the cooking chamber. The microwave generator may be mounted to the waveguide at one end portion of the waveguide. An opening may be formed in an opposite end portion of the waveguide through which the microwave energy may enter the cooking chamber. The opposite end portion of the waveguide may be opposite to the one end portion of the waveguide.

### CROSS-REFERENCE TO RELATED APPLICATIONS

This application claims priority to U.S. Provisional Patent Application Ser. No. 62/036,612, filed Aug. 12, 2014, which is incorporated by reference herein in its entirety.

### BACKGROUND OF THE INVENTION

1. Field of the Invention

The present invention relates generally to cooking apparatus that use cooking media, and use of a microwave generator to heat and cook food products.

2. Description of Related Art

Known fryers, e.g., open-well fryers and pressure fryers, are used to cook various food products, e.g., poultry, fish, potato products, and the like. Such fryers may include one or more cooking vessels, e.g., fryer pots, which may be filled with a cooking medium, e.g., an oil, a liquid shortening, or a meltable-solid shortening. Such fryers also include a heating element, e.g., an electrical heating element, such as a heating oil medium, or a gas heating element, such as a gas burner and gas conveying tubes, which heat the cooking medium in the cooking vessel. The amount of time sufficient to cook or to complete the cooking of the food product at a given cooking temperature depends on the type of food product that is cooked.

To satisfy the need for quick food service, food products are often pre-cooked and held in a holding cabinet prior to being served. Such a holding period may decrease the quality of the food product. Similarly, additional cooking apparatus may be used to provide a sufficient supply to meet production demands for quantity of food products and speed of cooking. Prior cooking apparatus have incorporated a microwave generator as the lone heating source to heat oil for cooking food products, but still suffer from longer cooking times and microwave cooking alone cannot match the taste, texture, or appearance of the food product cooked by frying. In addition, prior cooking apparatus have positioned the microwave generator on the bottom or the top of the cooking apparatus, for example, using an antenna to direct the microwaves into the cooking area. Those cooking apparatus, however, suffer from a loss of efficiency of the microwave generator since a portion of the microwaves are not delivered directly to the food product and/or are absorbed or lost through the transfer of energy from the microwave generator to the cooking area.

### SUMMARY OF THE INVENTION

Therefore, a need has arisen for cooking apparatus that provide decreased cooking times for food products, such that the total amount of time needed to prepare a certain quantity of food is reduced, while providing a more efficient use of microwave energy.

In an embodiment of the invention, a cooking apparatus may include a cooking chamber, a heating mechanism, a microwave generator, and a waveguide. The cooking chamber may hold cooking media. The heating mechanism may be disposed at the cooking chamber and may heat the cooking media. The microwave generator may produce microwave energy. The waveguide may be disposed on the cooking chamber and may transmit the microwave energy from the microwave generator to the cooking chamber. The microwave generator may be mounted to the waveguide at one end portion of the waveguide. An opening may be formed in an opposite end portion of the waveguide through which the microwave energy may enter the cooking chamber. The opposite end portion of the waveguide may be opposite to the one end portion of the waveguide.

Other objects, features, and advantages of the present invention will be apparent to persons of ordinary skill in the art in view of the foregoing detailed description of the invention and the accompanying drawings.

### BRIEF DESCRIPTION OF THE DRAWINGS

For a more complete understanding of the present invention, needs satisfied thereby, and the objects, features, and advantages thereof, reference now is made to the following description taken in connection with the accompanying drawings.

FIG. 1 is a side view of a fryer apparatus, according to an embodiment of the invention.

FIG. 2 is a perspective side view of a fryer apparatus, according to an embodiment of the invention.

FIG. 3 is an enlarged side view of a fryer apparatus, according to an embodiment of the invention.

FIG. 4 is a perspective top view of a fryer apparatus, according to an embodiment of the invention.

FIG. 5 is a perspective side view of the inside of a fryer apparatus, according to an embodiment of the invention.

FIG. 6 is a perspective side view of the inside of a fryer apparatus, according to an embodiment of the invention.

FIG. 7 is a bottom view of a lid of a fryer apparatus, according to an embodiment of the invention.

FIG. 8 is a perspective view of a choke system for a lid of a fryer apparatus, according to an embodiment of the invention.

FIG. 9 is a perspective top view of a fryer apparatus, according to an embodiment of the invention.

FIG. 10 is a flowchart showing a method for cooking food product using a fryer apparatus according to an embodiment of the invention.

### DETAILED DESCRIPTION OF EMBODIMENTS OF THE INVENTION

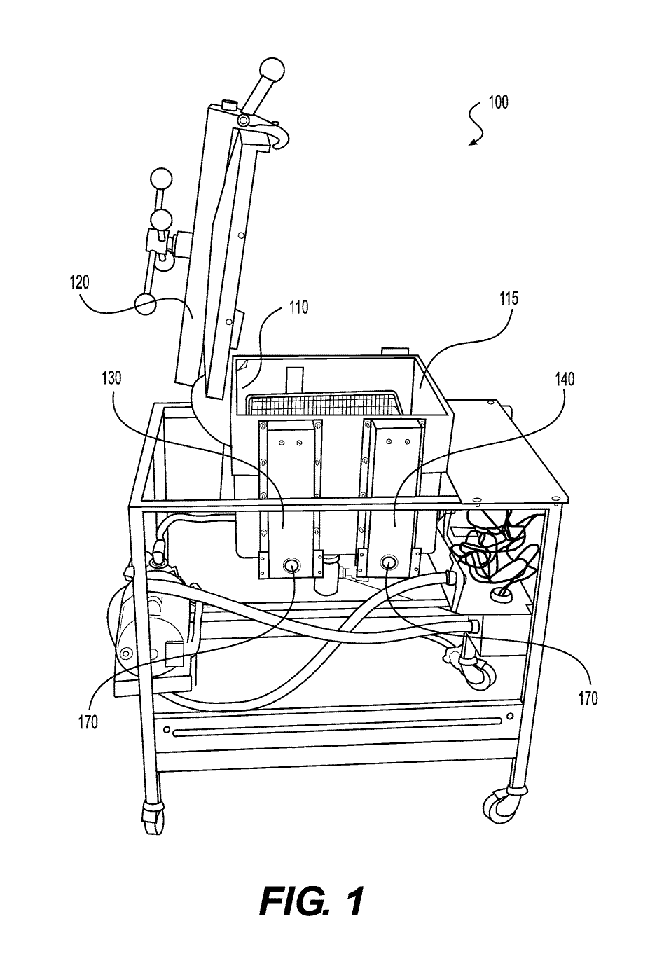

Embodiments of the present invention, and their features and advantages, may be understood by referring to FIGS. 1-9, like numerals being used for corresponding parts in the various drawings.

According to FIG. 1, a fryer apparatus 100 may comprise a cooking chamber 110. Although only one cooking chamber 110 is depicted in FIG. 1, in other embodiments of the invention, multiple cooking chambers may be used. Fryer apparatus 100 comprises cooking chamber 110 having an opening 115 for receiving a food product. Further, fryer apparatus 100 may comprise a lid 120 configured to cover opening 115 during cooking of the food product. For example, lid 120 may be connected with cooking chamber 110 using an attachment structure, such as a hinge structure, a slide-permitting structure, a counterbalanced horizontal lifting structure, or the like. Further, lid 120 may include a latching mechanism configured to engage when lid 120 is in a closed position with respect to cooking chamber 110. In some configurations, fryer apparatus 100 may be structured as an open fryer with a lid. In other configurations, fryer apparatus 100 may be a pressure fryer or some combination of an open fryer and a pressure fryer, for example. In embodiments in which fryer apparatus 100 includes a pressure fryer function, fryer apparatus 100 may comprise a modified or alternative version of lid 120 with a different arrangement, connection structure, and sealing structure, for example, and fryer apparatus 100 may comprise additional seals around access holes 510, which are described below in more detail. Such seals may be pressure-tight seals that may create a pressure-tight environment within cooking chamber 110.

A first waveguide 130 may be disposed on a side of cooking chamber 110. Waveguide 130 is configured for electromagnetic wave propagation at microwave wave frequencies. For example, waveguide 130 may be a substantially rectangular metallic box structure. Waveguide 130 may be attached to one or more sides of cooking chamber 110 with attaching means, such as bolts, screws, or the like, or may be welded to such one or more sides of cooking chamber 110. Alternatively, waveguide 130 may be integrally formed with one or more sides of cooking chamber 110. A second waveguide 140 similar to first waveguide 130 may be disposed on a side of cooking chamber 110. In alternative embodiments, other methods of providing electromagnetic wave propagation may be used, such as coaxial cables in place of waveguides.

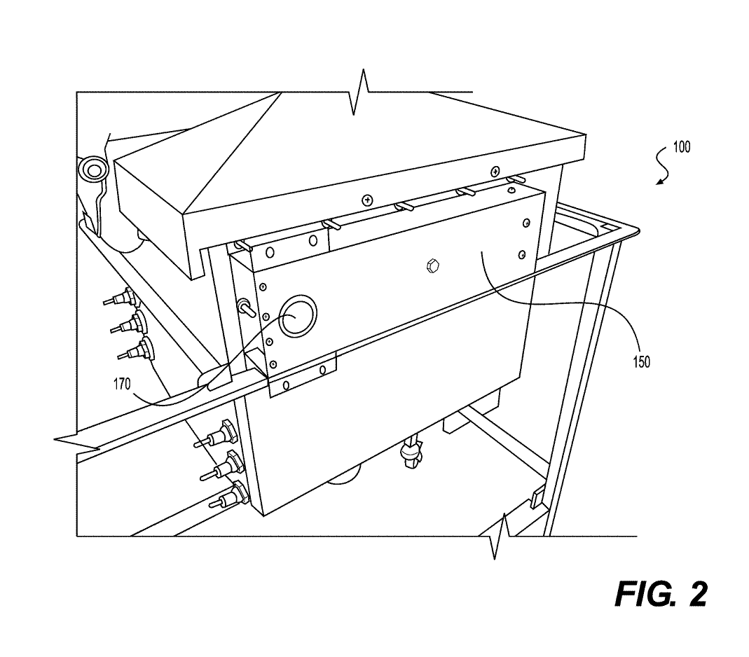

FIG. 2 is a perspective side view of a fryer apparatus, depicting the side opposite to the side depicted in FIG. 1. A third waveguide 150 may be disposed on this opposite side of cooking chamber 110. Thus, fryer apparatus 100 may comprise a plurality of waveguides. In alternative embodiments, fryer apparatus 100 may comprise a single waveguide or any number of a plurality of waveguides. Each of waveguides 130 and 140 may be disposed extending substantially vertically with respect to cooking chamber 110, while waveguide 150 may be disposed extending substantially horizontally with respect to cooking chamber 110. Alternatively, waveguides 130 and 140 may be arranged in any manner opposing waveguide 150 at an angle of substantially 180 degrees. In alternative embodiments, waveguides on opposite sides of fryer apparatus 100 may be arranged at any angle or may all be disposed at the same angle with respect to cooking chamber 110. For example, each of waveguides 130, 140, and 150 may be disposed extending substantially vertically with respect to cooking chamber 110, or extending substantially horizontally with respect to cooking chamber 100. As depicted in FIG. 2, waveguide 150 may be disposed closer to the top of cooking chamber 110 than to the bottom of cooking chamber 110. In addition, FIG. 2 depicts lid 120 in the closed position over the top of cooking chamber 110. In alternative embodiments, a waveguide or waveguides may be positioned on any side, including the top and bottom, of fryer apparatus 100. As another example, wave guides may be integrated with or attached to adjacent sides of cooking chamber 100 or even integrated with or attached to three or more sides of cooking chamber 100. As a still further example, one or more waveguides may be integrated with or attached to lid 120. These alternative arrangements of one or more waveguides on one or more sides of the cooking chamber may be used to obtain the optimal distribution of microwaves within a particular cooking chamber.

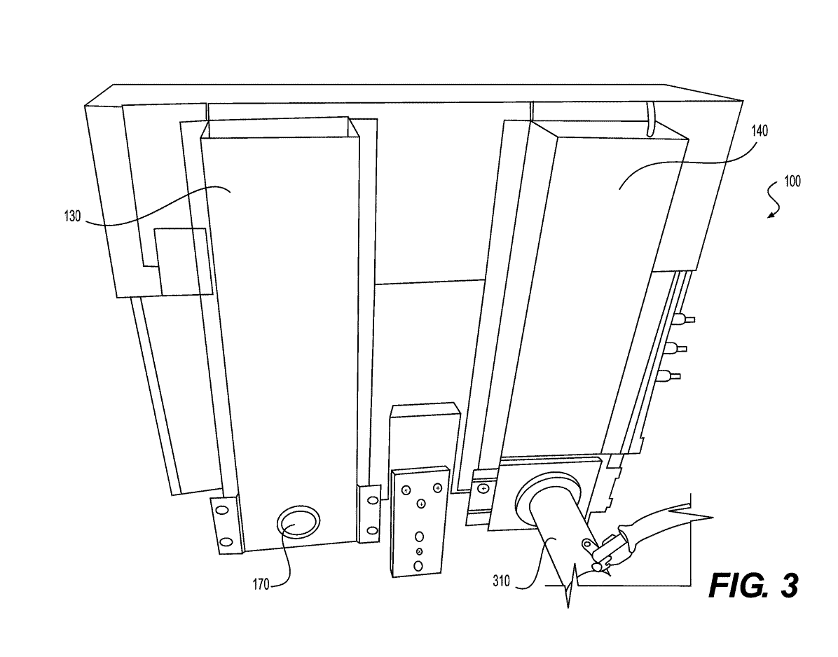

As depicted in FIGS. 1 and 2, each of waveguides 130, 140, and 150 includes an opening 170 formed on a side of the waveguide. Referring to FIG. 3, each of openings 170 may be configured to allow for connection of a microwave generator 310, which may be, for example, a magnetron for producing microwave energy. Thus, for example, each of waveguides 130, 140, and 150 may be connected to a corresponding microwave generator 310. The microwave energy produced by each of microwave generators 310 is directed through each of waveguides 130, 140, and 150, respectively, with little or no loss. As depicted in FIGS. 1-3, for example, each of openings 170 may be disposed closer to one end of the respective waveguides 130, 140, and 150.

In the depicted fryer apparatus 100, each of microwave generators 310 may be configured to generate 1 kW for a total power generation of 3 kW. Alternatively, any size and number of microwave generators, or a single microwave generator, may be used to generate a predetermined power output. For example, the microwave power generated may be from 1 watt to 10,000 watts or more. In general, the higher the power output, the shorter the cooking time required to cook a particular food product.

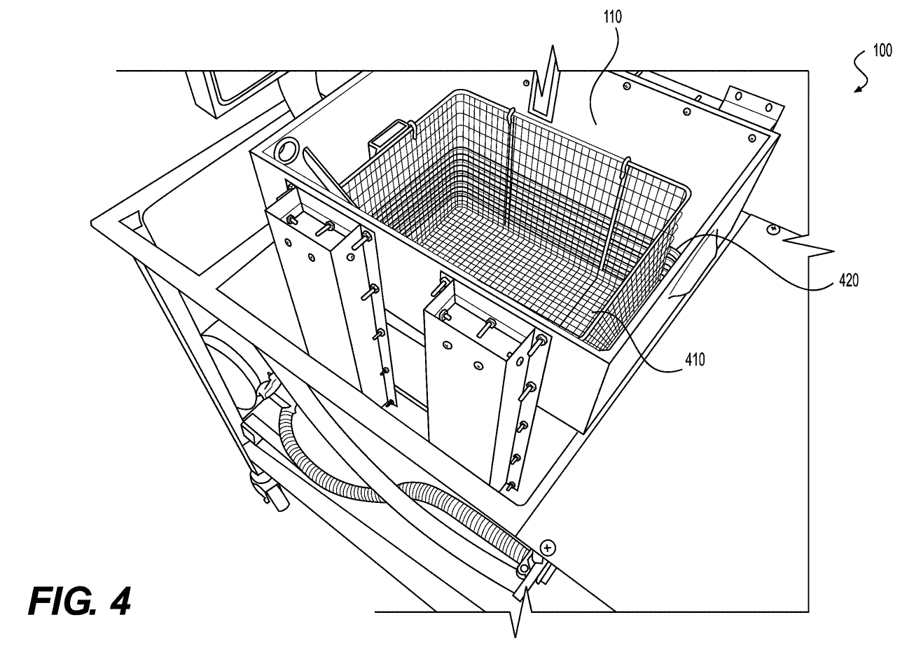

FIG. 4 is a perspective top view of fryer apparatus 100. Cooking chamber 110 may be configured to hold cooking media (e.g., an oil, a liquid shortening, or a meltable-solid shortening) therein. A wire basket 410 may be disposed within cooking chamber 110. Wire basket 410 may be configured to hold food product therein. A heating mechanism 420 may be disposed at or near the bottom of cooking chamber 110. In some configurations, heating mechanism 420 may be disposed outside of cooking chamber 110. Heating mechanism 420 may be configured to heat a quantity of cooking medium held in cooking chamber 110, which thereby heats and cooks the food product held in wire basket 410. Heating mechanism 420 may be a heater, such as a resistance heater, a heat exchanger, or another type of heating mechanism, for example. Accordingly, at least a portion of wire basket 410 may be submerged in the quantity of cooking medium held in cooking chamber 110. Wire basket 410 may be at least partially made of metal or made from a non-conduction material, such as high temperature plastic, ceramic, or other suitable material or combination of materials, or some hybrid combination thereof.

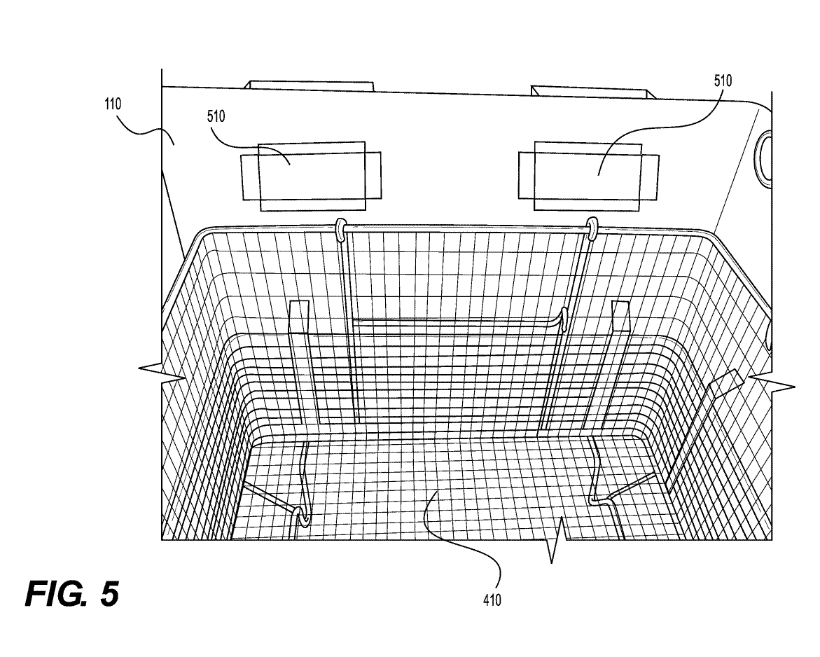

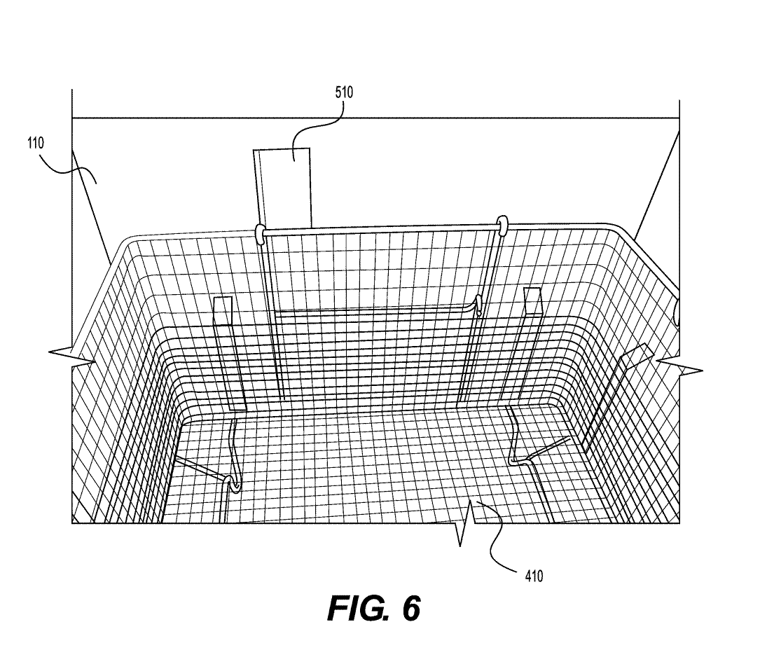

An access hole 510 (i.e., an iris), as depicted in FIGS. 5 and 6, may be disposed closer to an opposite end of each of waveguides 130, 140, and 150, which is opposite to the one end portion at which each of openings 170 is disposed. Access hole 510 may be configured to extend along a direction opposite to the direction in which the respective waveguide extends. For example, for waveguides 130 and 140 that extend substantially vertically, access hole 510 may extend substantially horizontally, as depicted in FIG. 5. Similarly, for waveguide 150 that extends substantially horizontally, access hole 510 may extend substantially vertically, as depicted in FIG. 6. In alternative embodiments, other methods may be used to transmit microwave energy through the interface into the cooking chamber, such as an antenna feedthrough mechanism in which, for example, a wire or metal insert picks up the microwave energy and transmits it into the cooking chamber.

Each of access holes 510 may be disposed at a position on cooking chamber 110 that is above a maximum level of cooking media held in cooking chamber 110. Further, each of access holes 510 may be substantially above the top of wire basket 410. This arrangement is suitable for reducing contact with the cooking media, especially when heated to cooking temperature, and preventing any arcing events with basket 410. Each of access holes 510 may also have a seal that is nearly microwave invisible but may sustain the temperature of the heated cooking media and prevent cooking media from exiting cooking chamber 110. For example, the seal may be comprised of polytetrafluoroethylene (PTFE), Polyetheretherketone (PEEK), ceramic, quartz, Ultra High Molecular Weight Polyethylene (UHMW), and/or other suitable material. In alternative embodiments, one or more access holes 510 may be disposed at a position on cooking chamber 110 that is below the level of cooking media. In such alternative embodiments, fryer apparatus 100 may comprise an auto-fill system configured to maintain the level of cooking media above the one or more access holes 510. An object that is nearly microwave invisible may absorb an insubstantial amount of microwave energy such that the absorbed microwave energy may result in the nearly microwave invisible object is heated by only an insubstantial amount that will not cause the object to breakdown after a number of uses.

In some embodiments, one or more access holes 510 may be disposed at locations along the waveguide other than at an end of the waveguide. For example, a plurality of access holes 510 may be disposed along the waveguide, which may produce even heating along an extended (e.g., 1 m long) waveguide. Moreover, if basket 140 is formed from a non-conduction material and/or the distance between a conductive basket 140 and access holes 510 is sufficiently large, arcing events with basket 410 may be reduced or eliminated, and the location of access holes 510 may be freely disposed with little, if any, regard to the position of basket 140.

Microwave energy transmitted from respective microwave generators 310 through waveguides 130, 140, and 150, enters cooking chamber 110 through access holes 510. The microwave energy that enters cooking chamber 110 contributes to cooking the food products in fryer apparatus 100, along with the heated cooking medium. Thus, the amount of time required to cook a particular food product or particular food products may be reduced. The arrangement and structure of each of waveguides 130, 140, and 150, each of microwave generators 310, and each of access holes 510 may be optimized through impedance matching. Accordingly, the size, shape, and location of each of waveguides 130, 140, and 150 may be determined to minimize loss, increase efficiency of the microwave system, and increase the life of the microwave generator.

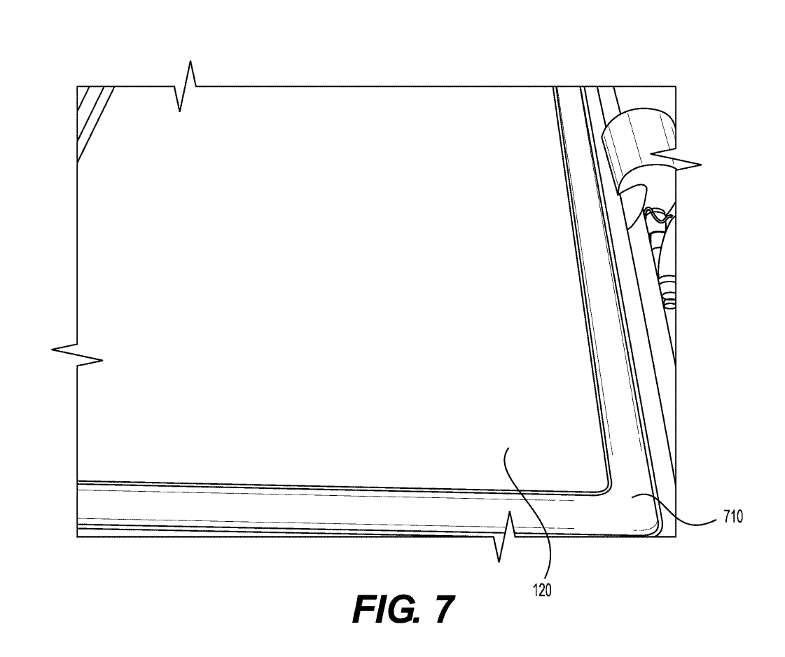

FIG. 7 is a bottom view of lid 120 of fryer apparatus 100, according to an embodiment of the invention. Lid 120 may have a metal mesh gasket 710 around an inner perimeter portion of lid 120. Metal mesh gasket 710 may provide a microwave seal for lid 120. In alternative embodiments, a suitable alternative material may be used for a lid gasket to achieve a microwave seal. For example, other electrically conductive materials may operate as a microwave seal prevent most, if not all, generated microwaves from being transmitted through lid 120.

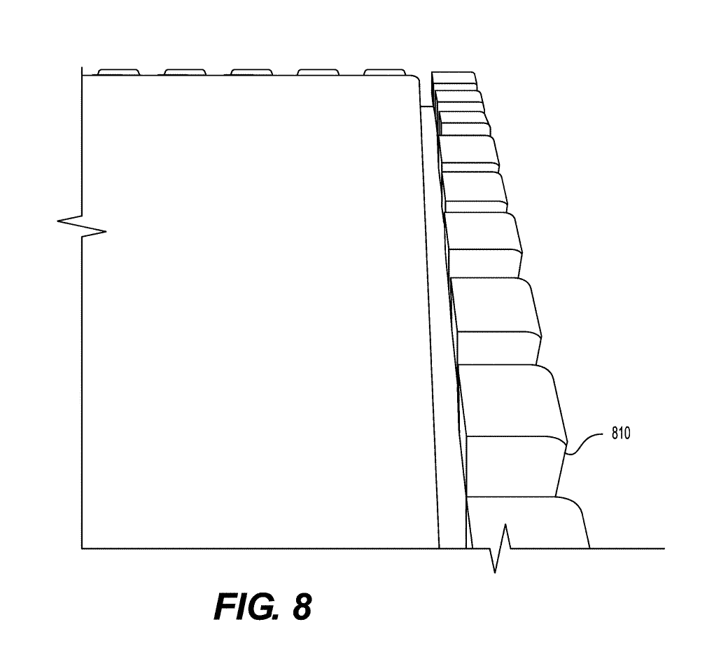

FIG. 8 is a perspective view of a choke system 810 for lid 120 of fryer apparatus 100, according to an embodiment of the invention. As an alternative to, or in addition to a gasket, choke system 810 may be provided for lid 120. Choke system 810 may be configured to provide high impedance of microwaves based on the impedance-transformation properties of quarter-wave lines. Choke system 810 may prevent microwaves from being transmitted outside of cooking chamber 110.

With lid 120 in the closed position, a microwave sealed cavity is created in cooking chamber 110, which may be a metallic box-like shape. With access holes 510 in the positions depicted in the accompanying drawings, microwave energy enters wire basket 410 through the top, open portion of wire basket 410. The microwave energy contributes to cooking food products held in wire basket 410, such that the total time required to cook a particular food product may be reduced.

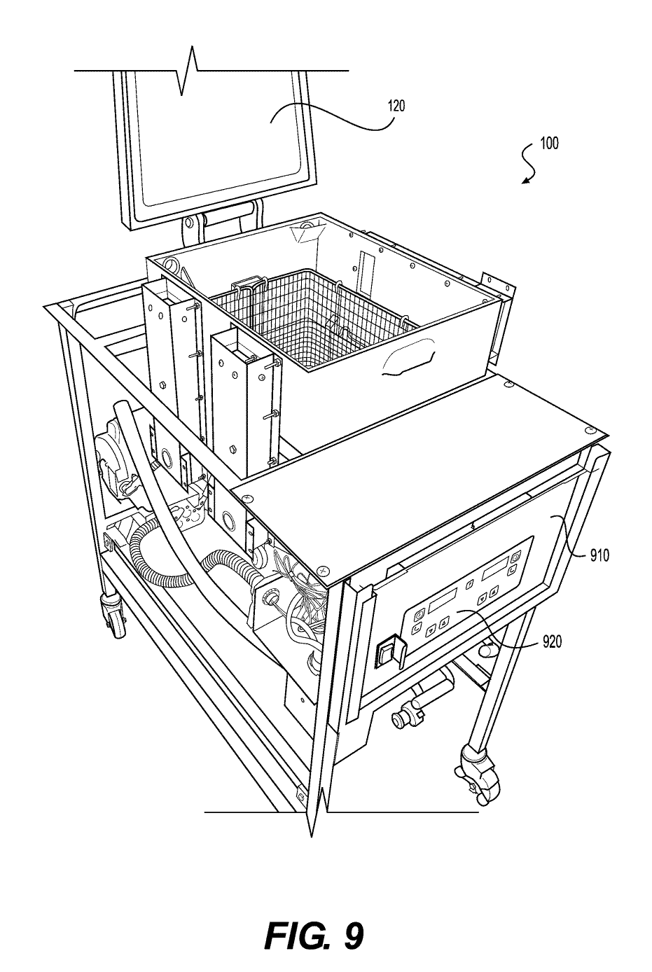

FIG. 9 is a perspective top view of fryer apparatus 100, according to an embodiment of the invention. Lid 120 is depicted in the open position and wire basket 410 is installed in cooking chamber 110 in FIG. 9. Fryer apparatus 100 may include a control device 910 configured to control operations of fryer apparatus 100. Control device 910 may comprise one or more processors configured to execute computer-readable instructions stored on a non-transitory storage medium, such as ROM, RAM, a hard disk drive, flash memory, or the like. A control panel 920 may be positioned on a front panel of fryer apparatus 100. Control panel 920 may comprise a plurality of buttons, screens, switches, knobs, and/or other input means or display means that may permit input to the control device 910 to activate and control components of fryer apparatus 100, such as heating mechanism 420 and microwave generators 310. Control panel 920 may include an audio or visual alarm to alert a user of a particular condition. Control device 910 may be configured to control the timing of activating and deactivating heating mechanism 420 and microwave generators 310, as well as components of the cooking medium system of fryer apparatus 100. Further, control device 910 may receive feedback from various sensors that measure various parameters of the fryer apparatus (e.g., temperature, pressure, cooking medium level, current, energy, or the like).

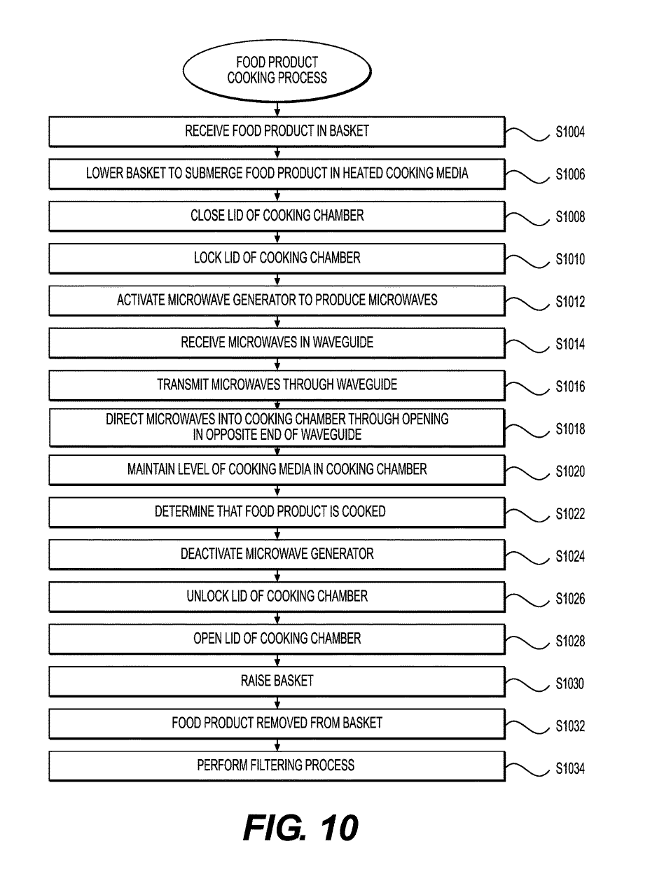

FIG. 10 is a flowchart showing a method for cooking food product using a fryer apparatus according to an embodiment of the invention. Control device 910 may implement the method shown in FIG. 10 by performing processes thereof or controlling other components of the fryer apparatus to perform processes thereof, for example. Control device 910 may initially activate a heating mechanism, such as heating mechanism 420, and begin heating cooking media in a cooking chamber, such as cooking chamber 110, for example. This heating process may be performed in response to a command input through control panel 920, at a predetermined time of day, such as a time shortly before a restaurant opens, or in response to other conditions or parameters.

In S1004, a receptacle in the cooking chamber, such as basket 410, may receive food product therein. Subsequently, in S1006 the receptacle may be lowered into the cooking chamber, such that an upper portion of the receptacle is disposed below an upper opening, such as an access hole 510, that is configured to permit entry of microwave energy into the cooking chamber. S1006 may be performed in response to a command input through control panel 920, in response to a predetermined amount of food product being disposed in the receptacle, or by manual operation. Control device 910 may control the lowering process, for example.

In S1008, a lid of the cooking chamber, such as lid 120, may be closed. The lid may include a seal, such as gasket 710, that may block microwave energy from exiting the cooking chamber. The lid may be configured to close automatically in response to a command input through control panel 920, in response to the receptacle may be lowered into the cooking chamber in S1006, by manual operation, or in response to other conditions or parameters. After the lid is closed, the lid may be locked in the closed position in S1010. For example, a latching mechanism may engage in response to the lid being closed and lock the lid in place. In some configurations, the lid may be locked manually. In some configurations, control device 910 may control one or more of the closing and locking processes of S1008 and S1010.

In S1012, after the lid has been placed in the closed position, control device 910 may activate a microwave generator, such as microwave generator 310. The microwave generator may thereafter produce microwave energy. In S1014, the microwave energy produced by the microwave generator may be directed to enter a waveguide, such as one or more of waveguides 130, 140, 150, through an opening, such as opening 170. Thus, the waveguide may receive the microwave energy therein. Thereafter, in S1016, the waveguide may transmit the microwave energy by directing the microwaves therethrough and toward the upper opening. In S1018, the waveguide may direct the microwave energy through the upper opening and into the cooking chamber. Because the receptacle is disposed below the upper opening, the microwave energy may travel toward the food product and assist with the cooking process. Moreover, the seal of the lid may block microwave energy from exiting the cooking chamber and potential harm to nearby persons and equipment.

In S1020, control device 910 may utilize one or more sensors to detect the level of cooking media in the cooking chamber. When the level of cooking media in the cooking chamber falls below a predetermined level, control device 910 may initiate an auto-fill process to add additional cooking media to the cooking chamber in order to maintain the level of cooking media at a desired level. In some cases, control device 910 may initiate an alert or other notice that notifies a user to add additional cooking media rather than initiating an autofill process. For example, control device 910 may operate to maintain the level of cooking media in the cooking chamber above the upper opening so that the microwave energy is transmitted directly into the cooking media from the waveguide, rather than being transmitted into air.

In S1022, control device 910 may determine that the food product is cooked. The determination of S1022 may be made in response to the lapse of a predetermined amount of cooking time, in response to an input through control panel 920, or in response to one or more other parameters or settings. In response to determining that the food product is cooked, the process may proceed to S1024, and control device 910 may deactivate the microwave generator to stop the generation of microwave energy.

In response to the microwave generator being deactivated, the process may proceed to S1026, and the lid may be unlocked. For example, control device 910 may maintain the lid in a locked state in the closed position until the microwave generator has been safely deactivate, which may prevent harm to nearby persons and equipment. In other cases, a mechanical lock may be physically prevented from opening until the microwave generator is deactivated in S1024, at which point the lid may be unlocked in S1026. Nevertheless, in some configurations, the lid may be unlocked at any time. In S1028, after the lid has been unlocked, the lid may be opened to access the cooked food product. In some configurations, control device 910 may control the lid to open. In other configurations, the lid may be opened by an urging member, such as a spring, after the lid is unlocked. In still other configurations, the lid may be manually opened by a user.

After the lid has been opened, the receptacle may be raised in S1030. In some configurations, a user may be required to raise the receptacle manually. In other configurations, control device 910 may control a motor to raise the receptacle in response to the lid being opened, in response to an input through control panel 920, or in response to some other command or parameter. In still other configurations, an urging member may urge the receptacle upwards in response to the lid being opened. Thereafter, in S1032, the cooked food product may be removed from the receptacle.

In S1034, control device 910 may utilize sensors to determine whether the cooking media needs to be replaced or filtered. Such sensors may determine the quality of the cooking media, the number of cooking cycles in which the cooking media has been used, or some combination thereof, for example. When control device 910 determines that the cooking media needs to be replaced or filtered, control device 910 may initiate an automated filtering or cooking media-replacement process or provide a notification for a user to perform such process.

Control device 910 may deactivate the heating mechanism and permit the cooking media to cool at certain times, such as at the end of the day, at set intervals for maintenance, when an input is received through control panel 920, or in response to other parameters and conditions, for example. In some configurations, control device 910 may periodically deactivate and reactivate the heating mechanism to adjust the temperature of the cooking media in the cooking temperature (e.g., to maintain a substantially steady temperature, to raise the temperature, to lower the temperature). Control 910 may monitor the temperature of the cooking media using one or more temperature sensors, such as thermocouples, electrodes, or other temperature-sensing devices, for example. In some configurations, processes S1004-S1034 may be performed a plurality of times prior to the heating mechanism being deactivated in, for example. In other configurations, the heating mechanism may be deactivated and reactivated a plurality of times during a single performance of processes S1004-S1034, for example.

Alternatively, one or more processes disclosed above may be omitted for a specific type of control. One such example would be performing a filtering process at S1034 without cooking food beforehand.

While the invention has been described in connection with certain embodiments, it will be understood by those of ordinary skill in the art that other variations and modifications of the embodiments described above may be made without departing from the scope of the invention. Other embodiments will be apparent to those of ordinary skill in the art from a consideration of the specification or practice of the invention disclosed herein. The specification and the described examples are considered as exemplary only, with the true scope and spirit of the invention indicated by the following claims.

1. A cooking apparatus comprising:
a cooking chamber configured to hold cooking media;
a heating mechanism disposed at the cooking chamber and configured to heat the cooking media in the cooking chamber;
a microwave generator configured to produce microwave energy; and
a waveguide disposed proximate to the cooking chamber and configured to transmit the microwave energy from the microwave generator to the cooking chamber,
wherein the microwave generator is mounted to the waveguide at one end portion of the waveguide,
wherein an opening is formed in an opposite end portion of the waveguide through which the microwave energy enters the cooking chamber, and
wherein the opposite end portion of the waveguide is opposite to the one end portion of the waveguide.

2. The cooking apparatus of claim 1, wherein the cooking apparatus is a pressure fryer.

3. The cooking apparatus of claim 2, further comprising:
a lid;
an attachment structure configured to attach the lid to the cooking chamber and to permit the lid to move between an open position and a closed position with respect to the cooking chamber; and
a latching mechanism configured to engage the lid when the lid is in the closed position with respect to the cooking chamber,
wherein the cooking chamber comprises a cooking chamber opening, and
wherein the lid is configured to cover the cooking chamber opening when the lid is in the closed position with respect to the cooking chamber.

4. The cooking apparatus of claim 3,
wherein the lid comprises a pressure-tight seal, and
wherein the opening formed in the waveguide comprises another pressure-tight seal that is nearly microwave invisible.

5.-6. (canceled)

7. The cooking apparatus of claim 1, wherein the waveguide contains an additional opening at the one end through which the microwave energy enters the cooking chamber, such that the microwave energy enters the waveguide through the additional opening and exits the waveguide into the cooking chamber through the opening formed in the waveguide.

8. (canceled)

9. The cooking apparatus of claim 1,
wherein the cooking apparatus further comprises a basket configured to hold food product therein, and
wherein the cooking apparatus is configured such that an upper portion of the basket is disposed below the opening formed in the waveguide when a cooking operation is performed.

10. The cooking apparatus of claim 1, wherein the cooking apparatus is configured to maintain a level of the cooking media in the cooking chamber above the opening formed in the waveguide.

11. The cooking apparatus of claim 1,
wherein the waveguide is configured to extend predominantly in a first direction, and
wherein the opening formed in the waveguide is configured to extend predominantly in a second direction substantially orthogonal to the first direction.

12. The cooking apparatus of claim 1, further comprising a seal configured to seal the opening formed in the opposite end portion of the waveguide,
wherein the seal is formed from a material comprising at least one of:
polytetrafluoroethylene,
ceramic,
quartz,
ultra high molecular weight polyethylene; and
polyetheretherketone.

13. The cooking apparatus of claim 1, further comprising:
a lid configured to cover a cooking chamber opening in the cooking chamber when the lid is in a closed position with respect to the cooking chamber;
an electrically conductive gasket extending around an inner perimeter portion of the lid,
wherein the electrically conductive gasket is configured to act as a microwave seal for the lid.

14. The cooking apparatus of claim 1, further comprising:
a lid configured to cover a cooking chamber opening in the cooking chamber when the lid is in a closed position with respect to the cooking chamber; and
a choke system configured to provide high impedance of microwaves based on the impedance-transformation properties of quarter-wave lines,
wherein the choke system is configured to block the microwave energy from being transmitted outside of the cooking chamber when the lid is in the closed position.

15. The cooking apparatus of claim 1, further comprising:
a control device configured to control operations of the cooking apparatus; and
a control panel configured provide an interface for inputting operational instructions for the cooking apparatus and to output operational information regarding the cooking apparatus.

16. The cooking apparatus of claim 1, further comprising an additional waveguide,
wherein the waveguide is disposed on a first side of the cooking chamber,
wherein the additional waveguide is disposed on a second side of the cooking chamber, and
wherein the second side is a side of the cooking chamber opposite to the first side.

17.-18. (canceled)

19. The cooking apparatus of claim 1, further comprising:
a lid configured to cover a cooking chamber opening in the cooking chamber when the lid is in a closed position with respect to the cooking chamber, wherein the lid is configured to prevent the microwave energy from escaping through the cooking chamber opening; and
a seal configured to thermally insulate the opening formed in the waveguide,
wherein the seal is configured to permit the microwave energy to pass through the opening formed in the waveguide, and
wherein the seal is configured to prevent cooking media from exiting the cooking chamber via the opening formed in the waveguide.

20. The cooking apparatus of claim 1,
wherein the cooking apparatus further comprises a basket configured to hold food product therein,
wherein the basket comprises a basket opening configured to receive the food product therethrough, and
wherein the opening formed in the waveguide and the basket opening are configured to be relatively disposed such that the microwave energy exits the opening formed in the waveguide and enters the basket through the basket opening during a cooking operation.

21. A fryer system comprising:
a cooking apparatus comprising:
a cooking chamber configured to hold cooking media and comprising a cooking chamber opening;
a basket configured to hold food product therein and comprising a basket opening configured to receive the food product therethrough;
a lid configured to cover the cooking chamber opening when the lid is in a closed position with respect to the cooking chamber, the lid comprising an electrically conductive gasket extending around an inner perimeter portion of the lid and configured to act as a microwave seal for the lid;
a heating mechanism disposed at the cooking chamber and configured to heat the cooking media in the cooking chamber;
a microwave generator configured to produce microwave energy; and
a waveguide disposed proximate to the cooking chamber and comprising:
a first opening through which the waveguide connects with the microwave generator;
a second opening through which the waveguide connects with an interior of the cooking chamber;
a seal that for the second opening that is nearly microwave invisible and that is configured to prevent cooking media from exiting the cooking chamber via the second opening;
a control device configured to control the activation of the microwave generator; and
a control panel comprising an input device configured to provide an input to the control device,
wherein the second opening is disposed closer than the first opening to the cooking chamber opening, and
wherein the waveguide is configured to transmit the microwave energy from the microwave generator through the first opening and out the second opening into the cooking chamber.

22. A method for cooking food product using a cooking apparatus, the method comprising:
heating cooking media in a cooking chamber using a heating mechanism;
producing microwave energy using a microwave generator;
receiving the microwave energy from the microwave generator in a waveguide disposed proximate to the cooking chamber, the microwave generator being mounted to the waveguide at one end portion of the waveguide; and
transmitting the microwave energy through the waveguide to an opening is formed in an opposite end portion of the waveguide through which the microwave energy enters the cooking chamber, the opposite end portion of the waveguide being opposite to the one end portion of the waveguide.

23. The method of claim 22, further comprising:
maintaining a level of the cooking medium in the cooking chamber above the opening formed in waveguide while cooking the food product.

24. The method of claim 22, further comprising:
maintaining a lid attached to the cooking chamber in a closed position with respect to the cooking chamber while cooking the food product, the lid comprising a microwave seal; and
blocking the microwave energy from exiting the cooking chamber through the lid using the microwave seal.

25. The method of claim 22, further comprising:
supporting a basket in the cooking chamber such that an upper portion of the basket is disposed below the opening formed in the waveguide while cooking the food product, the basket holding the food product therein.
